(19) United States
(12) Patent Application Publication
(10) Pub. No.: US 2007/0276872 A1
(43) Pub. Date: Nov. 29, 2007

(54) System and method for automated and structured transfer of technical documents and the management of the transferred documents in a database

(75) Inventors: Peter Beer, Mannheim (DE); Christian Kohlmeyer, Grunstadt (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 11/797,879

(22) Filed: May 8, 2007

(30) Foreign Application Priority Data
May 8, 2006 (DE) 10 2006 021 542.7
Feb. 23, 2007 (DE) 10 2007 008 904.1

(51) Int. Cl. G06F 17/00; G06F 17/30; G06F 7/00

(52) U.S. Cl. 707/104.1; 707/100; 707/1; 715/500

(57) ABSTRACT

A system and a method are disclosed for the automated and structured transfer of technical documents and the management of the transferred documents in a database of an engineering process or an engineering project with at least one data source, in which the documents are stored in electronic form. One or more structures for storing the documents are implemented in the database. The structures are identifiable by means of an assigned identification feature. The data source interacts with an assignment module, which allocates each document a document identification number for unique assignment into one of the structures of the database. The data source further interacts with a sort module, which files the documents dependent on their document identification number in the structure identifiable by the identification feature in the database, and makes the documents available for further processing.

### RELATED APPLICATIONS

This application claims priority under 35 U.S.C. §119 to German Application 10 2006 021 542.7 filed in Germany on May 8, 2006, and German Application 10 2007 008 904.1 filed in Germany on Feb. 23, 2007, the entire contents of which are hereby incorporated by reference in their entireties.

### TECHNICAL FIELD

The disclosure relates to a system for automated and structured transfer of technical documents and the management of the transferred documents in a database of an engineering process or an engineering project. The disclosure further relates to a method with which the technical documents, related to the overall documentation of the technical process or the technical project, are stored and managed in suitable structures in automated operations.

### BACKGROUND INFORMATION

Known methods for structured storage of documents, in particular project and/or process documents, in overall documentation of a technical process or a technical project, are based on manual filing of the relevant documents. This involves assembling the documents from several data sources, such as computer programs, the Internet, manufacturer documentation, CDs or external databases, and combining them to form overall documentation. Because of the manual filing of the documents into the overall documentation, this procedure is very time-intensive and liable to errors. The time required increases in proportion to the number of documents to be filed, and is very difficult to estimate accurately in advance. Furthermore, errors resulting from the manual filing are often not reproducible.

Since the manually merged overall documentation is often created from different sources, it is usually not homogeneous, and is thus difficult for a user to handle. Because of the extensive time required for manual maintenance of the overall documentation, it is difficult to keep the documentation status current at all times.

### SUMMARY

A system and a method are disclosed for automated and structured transfer of technical documents and the management of the transferred documents in a database of an engineering process or an engineering project, whereby aforementioned disadvantages of prior art are overcome.

An exemplary system for automated and structured transfer of technical documents and the management of the transferred documents in a database of an engineering process or a database of an engineering project, includes at least one data source in which the documents are stored in electronic form, processing of the documents being possible in any formats.

The database can be a project database for storing overall documentation of a technical engineering process or a technical engineering project. One or more structures for storing the documents are implemented in the database, the structures being identifiable by means of an assigned identification feature. The structures form an overall structure, which can also be described as overall documentation. Within the overall documentation, any number of structures can be defined, followed by the respective documents to be filed.

### BRIEF DESCRIPTION OF THE DRAWINGS

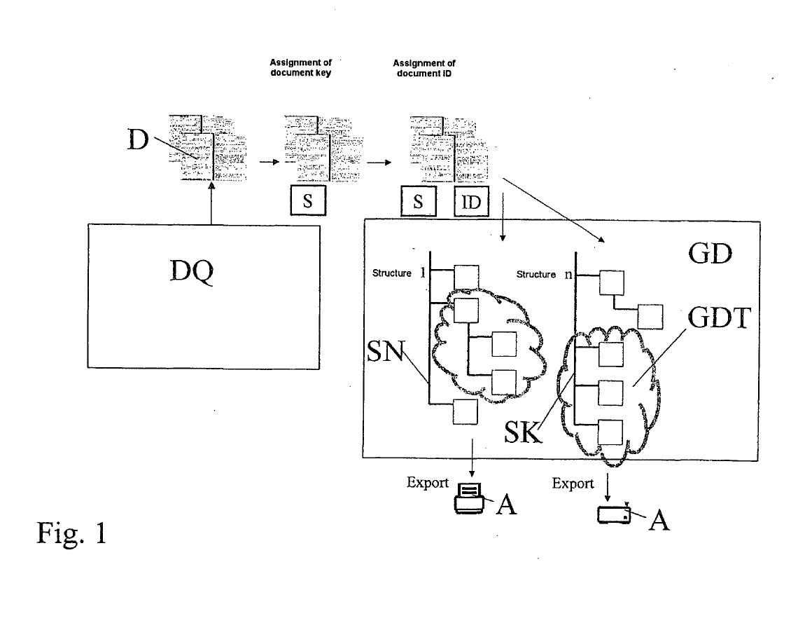

The exemplary embodiment of a system for filing a technical document D in an overall documentation GD as shown in FIG. 1 is explained and described, along with advantageous developments, improvements and further advantages of the invention.

### DETAILED DESCRIPTION

FIG. 1 shows an exemplary embodiment of the system for filing a technical document D in an overall documentation GD, the element to be filed being supplied from a data source DQ. A unique document identification number ID is assigned to the document D to be filed. This document identification number ID follows any freely selectable structure SN, SK, also called the document type key S, which follows for example a general standard, a company's internally used structure and/or a customer structure.

The totality of all document identification numbers ID is managed here by means of a management model, not shown, the document identification numbers ID serving for unique identification of a permanently defined document type.

The document D to be classified in the overall documentation GD is transferred into a centrally managed database and filed in the selected structure(s) SN, SK. The centrally managed database maps the overall documentation GD.

The underlying tables of contents and cover pages for the overall documentation GD are furthermore created and/or updated.

In an exemplary development, it is provided that by means of an export function, the overall documentation GD or parts of the overall documentation GDT are fed with all or selected documents inclusive of the underlying structures to an output unit A, and for example exported to an electronic data memory, or printed out in paper form.

One or more structures for storing the documents can be implemented in a database, the structures being identifiable by means of an assigned identification feature. The structures form an overall structure, which can also be described as overall documentation. Within the overall documentation, any number of structures can be defined, followed by the respective documents to be filed.

A data source interacts with an assignment module, which allocates each document a document identification number for unique assignment into one of the structures stored in the database. The document identification number thus includes information indicating the structure of the overall documentation into which the relevant document should be classified.

The data source further interacts with a sort module, which files the documents dependent on their document identification number in the structure identifiable by the identification feature in the overall documentation, and makes the documents available for further processing.

As data sources for the supply of the technical documents, electronic data collections such as manufacturer documentation stored on electronic data carriers, or documents available on the Internet and/or external databases, can be used. With automatic referencing on the Internet and/or intranet to documents available there, it is thus possible to access these documents, and the documents can be transferred at a freely selectable time by being copied into the structure. The reference(s) generated by the automatic referencing on the Internet can for example point to documents within process/project-internal networks, but equally to external network structures, and also to device descriptions of external suppliers. The overall documentation and/or parts of the same can thus be kept independent of location and up-to-date at any time.

The documents stored in the data source can be project and/or process documents, such as measurement, consumer and/or cable lists, control & instrumentation schemes, wiring diagrams, equipment plans, terminal connection diagrams, and cabinet and/or device documentation.

For the management and provision of the document identification numbers for the documents stored in the data sources, a management module is provided, which checks for example how many numbers are still unused in the underlying structures (freely selectable and/or still to be created).

The database or overall structure into which the documents are being classified can be a centrally managed database.

In an exemplary embodiment, during the filing of the documents, a standard table of contents and a cover page can be automatically generated for the respective documents, also known as document packages, stored in the individual structures.

It is also provided for the documents to be automatically allocated one or more drawing numbers. In the management of the drawing numbers, it is advantageously checked how many drawing numbers are still unused in the underlying freely selectable and/or creatable nomenclatures, and only the free drawing numbers are issued.

An exemplary method is based on that one or more structures for storing the documents are implemented in the database, and the structures are identified by means of an assigned identification feature.

The documents stored in the data source in electronic form are each allocated a document identification number by means of an assignment module, for unique assignment into one of the structures of the database, and by means of a sort module the documents thus marked are filed, dependent on their document identification numbers, into the database structure which is identifiable by the identification feature, the documents then being made available for further processing.

Through the application of the exemplary method, the technical process and/or the technical project described by the overall documentation is advantageously documented in its totality, consistently, to be up-to-date and redundancy-free, with the minimum possible number of documents.

The exemplary method enables an automated representation of the document structure in graphic form, and supports an automated export of all or selected documents inclusive of the underlying structure(s) to electronic non-volatile storage, such as a computer hard disk or a CD-ROM.

The advantages of the described method are further based on the consistent management and creation of all documents of an overall documentation. Provided these documents exist at all in the overall documentation, the completeness of the documentation in relation to the facts under consideration is ensured with the help of the exemplary method. The overall documentation is reproducible at any freely selectable time both for reading use and for updating.

Through the automation of work steps, such as the management and issue of the drawing numbers, an increase in efficiency is possible at any time in the tracking of a technical process and/or project.

The exemplary system and method can be used in process planning, system planning or control and instrumentation planning for the creation and management of the overall documentation. However, they can also be applied in the creation of technical documentation for process engineering, plant engineering, system engineering, automation engineering, electrical engineering and cabling.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. System for automated and structured transfer of technical documents and the management of the transferred documents in a database of an engineering process or an engineering project, with at least one data source, in which the documents are stored in electronic form, where
one or more structures for storing the documents are implemented in the database,
the structures are identifiable by means of an assigned identification feature,
the data source interacts with an assignment module, with which a document identification number can be allocated to each document for unique assignment into one of the structures stored in the database,
the data source further interacts with a sort module, in which the documents can be filed dependent on their document identification number in the database structure which is identifiable by the identification feature, and can be further processed.

2. System according to claim 1, wherein the database is a project database for the generation of overall documentation for a technical process or a technical project.

3. System according to claim 1, wherein the identification features contain information for the structured classification of the documents in the structures of the database.

4. System according to claim 1, wherein the data sources are electronic data collections such as manufacturer documentation stored on electronic data carriers, or documents available on the Internet, and/or external databases.

5. System according to claim 1, wherein the documents stored in the data sources are preferably project and/or process documents.

6. System according to claim 1, wherein, for the management and provision of the document identification numbers for the documents stored in the data sources, a management module is provided.

7. System according to claim 1, wherein the database for the transfer and management of the transferred documents is a centrally managed database.

8. System according to claim 1, wherein, during the filing of the documents, a table of contents and a cover page can automatically be generated for the respective documents stored in the individual structures.

9. System according to claim 1, wherein the documents can automatically be allocated one or more drawing numbers.

10. Method for the automated and structured transfer of technical documents and the management of the transferred documents in a database of an engineering process or an engineering project with at least one data source, in which the documents are stored in electronic form, where
one or more structures for storing the documents are implemented in the database,
the structures are identified by means of an assigned identification feature,
to each of the documents stored in the data source, a document identification number is allocated by means of an assignment module for unique assignment into one of the structures stored in the database,
by means of a sort module the documents are filed dependent on their document identification number in the database structure which is identifiable by the identification feature, and the documents are made available for further processing.

11. Method according to claim 10, wherein the document identification numbers are supplied and managed by a management module.

12. Method according to claim 10, wherein, during the filing of the documents, a table of contents and a cover page are automatically generated for the respective documents stored in the individual structures.

13. Method according to claim 10, wherein the documents are automatically allocated one or more drawing numbers.

14. Use of the system and method according to claim 10 in technical planning, in particular in process engineering, plant engineering, system engineering, automation engineering, electrical engineering or cabling.

15. System according to claim 2, wherein the identification features contain information for the structured classification of the documents in the structures of the database.

16. System according to claim 3, wherein the data sources are electronic data collections such as manufacturer documentation stored on electronic data carriers, or documents available on the Internet, and/or external databases.

17. System according to claim 4, wherein the documents stored in the data sources are preferably project and/or process documents.

18. System according to claim 5, wherein, for the management and provision of the document identification numbers for the documents stored in the data sources, a management module is provided.

19. System according to claim 6, wherein the database or the transfer and management of the transferred documents is a centrally managed database.

20. System according to claim 7, wherein, during the filing of the documents, a table of contents and a cover page can automatically be generated for the respective documents stored in the individual structures.

21. System according to claim 8, wherein the documents can automatically be allocated one or more drawing numbers.

22. Method according to claim 11, wherein, during the filing of the documents, a table of contents and a cover page are automatically generated for the respective documents stored in the individual structures.

23. Method according to claim 12, wherein the documents are automatically allocated one or more drawing numbers.

24. Use of the system and method according to claim 13 in technical planning, in particular in process engineering, plant engineering, system engineering, automation engineering, electrical engineering or cabling.

25. Method for electronic transfer of technical documents and management of the transferred documents in a database of an engineering process or an engineering project with at least one data source, comprising:
implementing one or more structure for storing the documents in the database,
identifying the one or more structure based on an assigned identification feature,
allocating a document identification number to a respective one of the documents stored in the data source for unique assignment into one of the one or more structure stored in the database, and
filing the documents based on the respective document identification number in the database structure identifiable by the identification feature.
